(19) United States
(12) Patent Application Publication
(10) Pub. No.: US 2006/0170556 A1
(43) Pub. Date: Aug. 3, 2006

(54) System for detecting an RFID tag

(75) Inventor: Chien-Hsing Fang, Hsing-Chu (TW)

Correspondence Address: SNELL & WILMER;ONE ARIZONA CENTER, 400 EAST VAN BUREN, PHOENIX, AZ, 85004-2202, US

(73) Assignee: LEXIN TECHNOLOGY INC.

(21) Appl. No.: 11/037,414

(22) Filed: Jan. 18, 2005

(51) Int. Cl. G08B 13/14; H04Q 5/22; G06F 7/00; G06K 7/00; H01Q 13/00

(52) U.S. Cl. 340/572.7; 340/10.1; 700/225; 235/439; 343/772

(57) ABSTRACT

A system for detecting a radio frequency identification tag on an object is provided. The system includes a tunnel having a characteristic linear dimension of a characteristic cross-section and/or having a straight portion and at least one curved portion. The characteristic linear dimension is particularly designed so that the operating frequency of antennas is lower than the cutoff frequency of the tunnel. The leakage of the electromagnetic waves transmitted by the antenna array hence will be reduced. The at least one curved portion is in connection with one end of the straight portion to prevent electromagnetic waves from transmitting out of the tunnel.

### FIELD OF INVENTION

The present invention relates to a system for detecting a radio frequency identification (RFID) tag.

### BACKGROUND OF THE INVENTION

The use of RFID tags for identifying a person or an object is well known. In general, such tags, when excited, produce a magnetic field, or in some cases an electric field, of a first frequency which is modulated with an identifying code. The tags may be either active tags, i.e., tags which have a self contained power supply or may be passive tags that require external excitation when it is to be read or disposed within the detection volume of a reader, or may be semi-active tags which combine the characteristics of active tags and passive tags. For the purpose of mass use, passive tags seem to be more economical than the other two types.

FIG. 1 shows a system for detecting a passive RFID tag. The system includes an antenna 101, a reader 103, and a computer 105. The antenna 101 is configured to transmit a detection signal at a certain radio frequency and, when a tag 109 on an object 107 is within the effective range of the antenna 101, to receive a reflection signal from the tag 109. The reflection signal is received by the reader 103 for identification. After the tag 109 is identified, the reader 103 informs the computer 105 for further processing. One problem of this system is that the detection might be interfered with by other electromagnetic sources therearound, such as another magnetic field generator.

In order to solve this problem, U.S. Pat. No. 6,094,173 discloses an antenna array for detecting a coded RFID tag signal generated by a tag during passage of the tag through a detection volume or a portal. The antenna array includes at least first and second antennas disposed at different positions around the periphery of the detection volume, and circuitry, having inputs connected to receive the respective output signals from the first and second antennas and an output connected to a signal receiver for decoding the detected signal. The circuitry provides an output signal including the respective output signals of the first and second antennas, and the sum of the output signals of the first and second antennas. Another patent, U.S. Pat. No. 6,696,954, also discloses an antenna array including a plurality of antenna loops disposed to define a portal or passageway or other detection region in which the plural antenna loops transmit and/or receive electromagnetic signals. A processor coupled to the plural antenna loops processes at least the received signals and/or transmitted signals. The plural antennas may be arrayed in a rectangular array, on hanging flexible substrates or other suitable arrangement, and may be coupled to the processor by a filter or selective switch. The processor may be coupled to a utilization system for cooperating therewith for performing a desired function.

Though U.S. Pat. No. 6,094,173 and U.S. Pat. No. 6,696,954 disclose an antenna array and a portal-like device to improve the detection of a tag, strong electromagnetic waves generated by the antenna array might influence the usage of electronic devices around the systems and, more seriously, can affect human health.

### SUMMARY OF THE INVENTION

The present invention provides a system for detecting a radio frequency identification tag on an object. The system includes a tunnel and an antenna array. The tunnel, having a characteristic linear dimension of a characteristic cross-section, is configured for the object to pass through. The antenna array, arranged along a perimeter of the characteristic cross-section, is configured to detect the radio frequency identification tag at an operating frequency when the object passes through the tunnel. The characteristic linear dimension is particularly designed so that the operating frequency is lower than a cutoff frequency of the tunnel. Accordingly, the power leakage of electromagnetic waves transmitted by the antenna array will be reduced around the tunnel.

The present invention further provides a system for detecting a radio frequency identification tag on an object. The system includes a tunnel and an antenna array. The tunnel, having a straight portion and at least one curved portion, is configured for the object to pass through. The antenna array, arranged along a perimeter of the straight portion, is configured to detect the radio frequency identification tag when the object passes through the tunnel. The straight portion has two opposite ends. The at least one curved portion is in connection with one of the two opposite ends to prevent electromagnetic waves generated by the antenna array from leaking out of the straight portion.

### BRIEF DESCRIPTION OF THE DRAWINGS

FIG. 1 illustrates a system for detecting an RFID tag of the prior art;

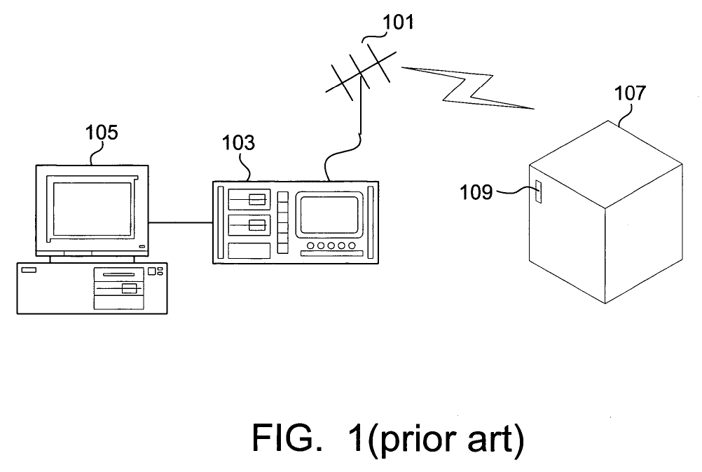

FIG. 2 illustrates a system for detecting an RFID tag in accordance with the first embodiment of the present invention;

FIG. 3 illustrates a system for detecting an RFID tag in accordance with the second embodiment of the present invention;

FIG. 4 illustrates a system for detecting an RFID tag in accordance with the third embodiment of the present invention; and

FIG. 5 illustrates a system for detecting an RFID tag in accordance with the fourth embodiment of the present invention.

### DETAILED DESCRIPTION

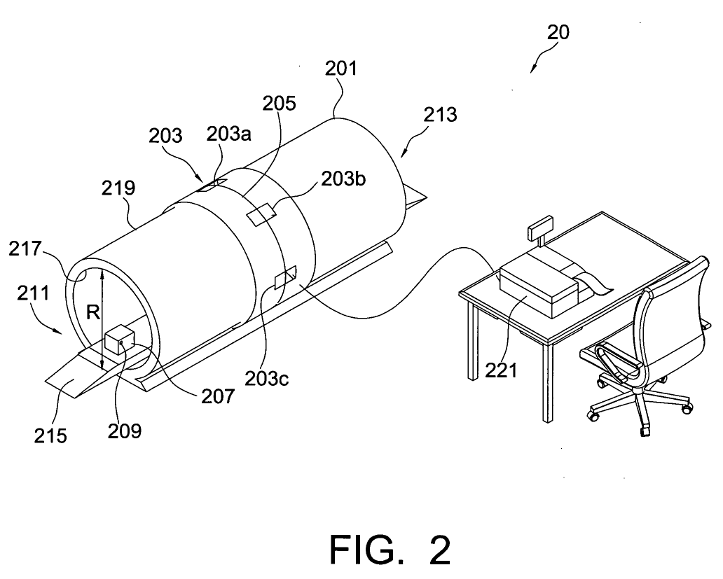

Referring to FIG. 2, a system 20 is suitable for use in a supermarket or department store to balance purchases. The system 20 includes a tunnel 201 and an antenna array 203.

The tunnel 201, having a characteristic linear dimension R of a characteristic cross-section 205, is suitable for an object 207 to pass through. In this embodiment, the characteristic cross-section 205 is a circular area and the characteristic linear dimension R is the diameter of the circular area. The antenna array 203, arranged along a perimeter of the characteristic cross-section 205, is for detecting, at an operating frequency, a radio frequency identification tag 209 on the object 207 when the object 207 passes through the tunnel 201. Although the characteristic cross-section 205 of the first embodiment is a circular area, the present invention does not limit its shape. For example, a rectangle may also work.

The electromagnetic waves generated by the antenna array 203 attenuate exponentially from the characteristic cross-section 205 to each of two openings 211 and 213 of the tunnel 201. The tunnel 201 has a cutoff frequency. According to the waveguide theorem, an electromagnetic wave at any frequency lower than the cutoff frequency, determined by the characteristic linear dimension R, will fail to transmit out of the tunnel 201. More particularly, the characteristic linear dimension R is inversely proportional to the cutoff frequency. Therefore, the characteristic linear dimension R may be designed to make the cutoff frequency larger than a predetermined operating frequency. Alternatively, an operating frequency is set to be smaller than a predetermined cutoff frequency. Either way can effectively reduce the probability that electromagnetic waves generated by the antenna array 203 transmit out of the tunnel 201. Such arrangement can thus avoid influencing the use of electronic devices around the system 20 and avoid affecting human health.

The system 20 further includes a conveyer 215, running from the opening 211 to the opening 213, and is configured to carry the object 207 and to control movement of the object 207. When the object 207 is carried close to the antenna array 203, the tag 209 can be detected.

The tunnel 201 includes an inner surface 217 and an outer surface 219. The inner surface 217 of the tunnel 201 is provided with a microwave absorber that can absorb electromagnetic waves generated by the antenna array 203 to substantially prevent the electromagnetic waves from transmitting out of the tunnel 201. The outer surface 219 is covered by a metal material to block some outer unexpected electromagnetic waves so that the detection will not be interfered with by unexpected outer electromagnetic waves.

The antenna array 203 includes four antennas, i.e., antennas 203a, 203b, 203c and one (not shown) opposite to 203b. The four antennas are equally spaced along the perimeter of the characteristic cross-section 205 to form a distinguishable pattern of an electromagnetic signal responsive to the tag 209. Nevertheless, the present invention does not limit the number of antennas of the antenna array. The system 20 further includes a processor 221, connected to the antenna array 203, for analyzing the distinguishable pattern and then identifying the object 207 by means of identifying the tag 209.

Because of the well-shielded system 20, the power of the antenna array 203 may be enlarged to clearly detect the tag 209 without hurting a nearby human body.

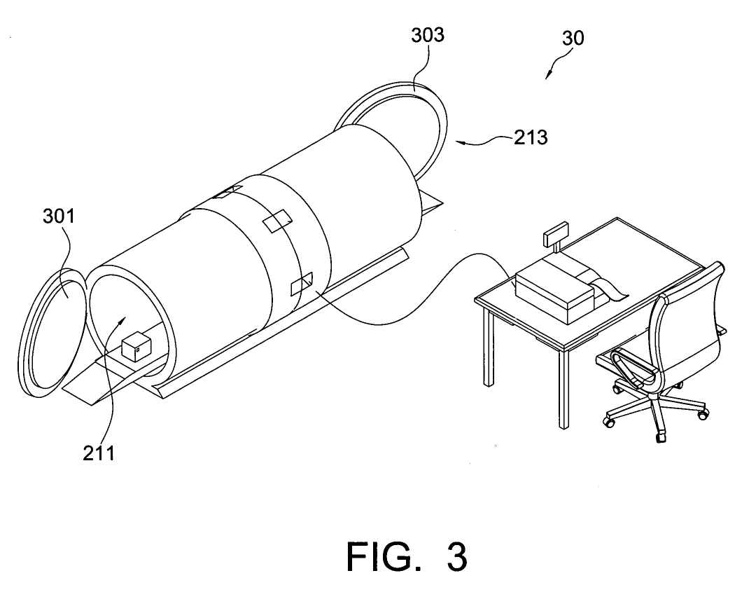

Referring to FIG. 3, a system 30, compared to the system 20, further includes two shields 301 and 303 to selectively cover the openings 211 and 213, respectively. When the shields 301 and 303 are closed, the electromagnetic waves will be isolated inside the tunnel. The shields 301 and 303 may be a conductive door, a screen or a curtain which movably attaches to the tunnel. Furthermore, the shields 301 and 303 may co-operate with the entrance of the object to, for example, avoid erroneously detecting some other objects which do not belong to the customer in a super market.

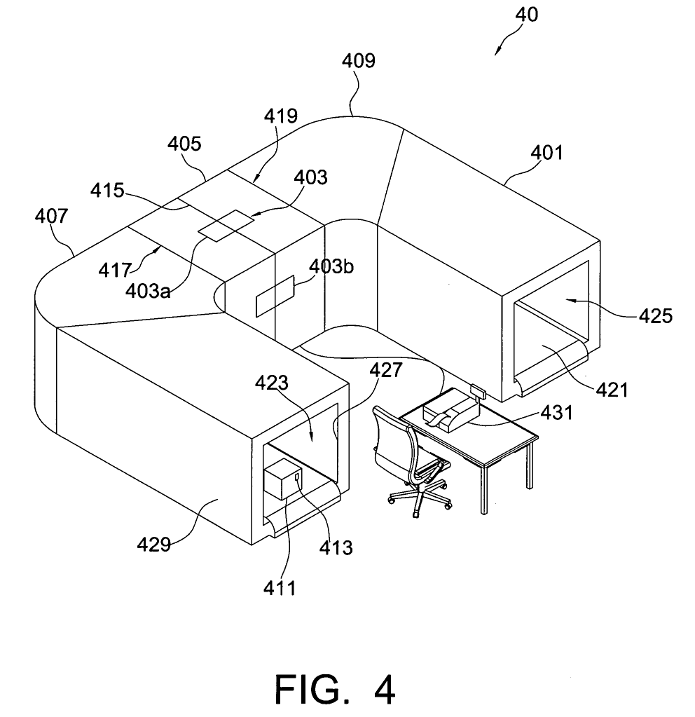

Referring to FIG. 4, a system 40 includes a tunnel 401 and an antenna array 403.

The tunnel 401, having a straight portion 405, a first curved portion 407 and a second curved portion 409, is configured for an object 411 with a tag 413 to pass through. In this embodiment, the cross-section of the straight portion 405 is a rectangular area. The straight portion 405 has two opposite ends 417 and 419. The first curved portion 407 is in connection with the end 417 and the second curved portion 409 is in connection with the end 419. The antenna array 403, arranged along a perimeter 415 of the straight portion 405, is configured to detect the tag 413 when the object 411 passes through the tunnel 401. Each of the first and second curved portions 407 and 409 turns by 90 degrees in the same direction with respect to the straight portion 405 so that the tunnel 401 has a U-shape. The first and second curved portions 407 and 409 limit electromagnetic waves generated by the antenna array 403 to staying in the tunnel 401.

The antenna array 403 includes four antennas, i.e., antennas 403a, 403b, one (not shown) opposite to 403a, and one (not shown) opposite to 403b. The four antennas are equally spaced along the perimeter 415 to form a distinguishable pattern of an electromagnetic signal reflected from the tag 413.

The tunnel 401 has a cutoff frequency determined by the perimeter 415. More particularly, the length of the perimeter 415 is inversely proportional to the cutoff frequency. Therefore, the perimeter 415 can be designed to make the cutoff frequency larger than the operating frequency. Alternatively, the operating frequency can be arranged to be smaller than the cutoff frequency. Either way can reduce the probability that electromagnetic waves generated by the antenna array 403 transmit out of the tunnel 401.

The system 40 further includes a conveyer 421, running from an opening 423 to an opening 425, configured to carry the object 411 and to control movement of the object 411. When the object 411 is carried close to the antenna array 403, the tag 413 can be detected.

The tunnel 401 includes an inner surface 427 and an outer surface 429. The inner surface 427 of the tunnel 401 is provided with a microwave absorber that can absorb electromagnetic waves generated by the antenna array 403 to substantially prevent the electromagnetic waves from transmitting out of the tunnel 401. The outer surface 429 is covered by a metal material so that the detection will not be interfered by some unexpected outer electromagnetic waves.

The system 40 further includes a processor 431, connected to the antenna array 403, for analyzing the distinguishable pattern and then identifying the object 411 by means of identifying the tag 413.

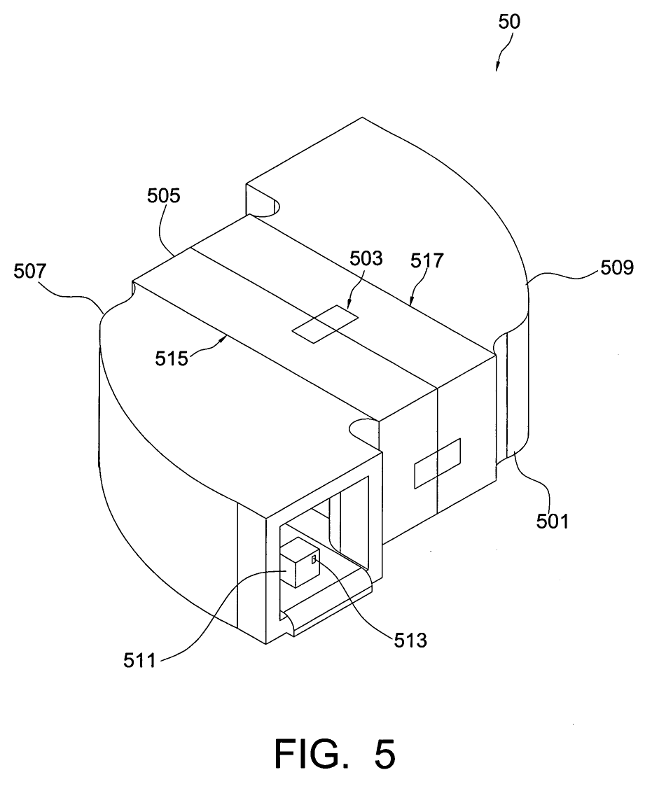

Referring to FIG. 5, a system 50 includes a tunnel 501 and an antenna array 503. The tunnel 501, having a straight portion 505, a first curved portion 507 and a second curved portion 509, is configured for an object 511 with a tag 513 to pass through. The straight portion 505 has two opposite ends 515 and 517. The first curved portion 507 is in connection with the end 515 and the second curved portion 509 is in connection with the end 517. A difference between the system 50 and the system 40 lies in that each of the first and second curved portions 507 and 509 turns by 90 degrees in the opposite direction with respect to the straight portion 505 so that the tunnel 501 has an S-shape. Similarly, the first and second curved portions 507 and 509 reduce the probability that electromagnetic waves generated by the antenna array 303 transmit out of the tunnel 301.

With any of the above-mentioned systems, the power of the antenna array may be increased without affecting human health and without interfering with other electronic devices around the systems. Applications of such technology may be used in super markets, department stores, retail establishments, warehouse stocks, travel facilities, government facilities, pharmacies, and the like. For example, in a super market, the system may detect the objects in a cart quickly and correctly without erroneously detecting the objects in a next cart.

Although preferred embodiments of the invention have been illustrated and described, it will be obvious to those skilled in the art that various modifications thereof can be made without departing from the scope and spirit of the invention defined by the appended claims.

1. A system for detecting a radio frequency identification tag on an object, comprising:
a tunnel, having a characteristic linear dimension of a characteristic cross-section, for the object to pass through; and
an antenna array, arranged along a perimeter of the characteristic cross-section, for detecting the radio frequency identification tag at an operating frequency when the object passes through the tunnel;
wherein the operating frequency is lower than a cutoff frequency that is determined by the characteristic linear dimension.

2. The system of claim 1, further comprising a conveyer, running through the tunnel, for carrying the object and controlling movement of the object.

3. The system of claim 1, wherein the tunnel comprises an inner surface and an outer surface, the inner surface is provided with a microwave absorber, and the outer surface is covered by a metal material.

4. The system of claim 1, wherein the antenna array comprises four antennas, equally spaced along the perimeter, for forming a distinguishable pattern of an electromagnetic signal responsive to the radio frequency identification tag.

5. The system of claim 1, further comprising a processor for analyzing an electromagnetic pattern of signal, from the object, detected by the antenna array.

6. The system of claim 1, wherein the tunnel has an opening and the system comprises a shield for selectively covering the opening.

7. The system of claim 1, wherein the characteristic cross-section is a circular area.

8. The system of claim 1, wherein the characteristic cross-section is a rectangular area.

9. The system of claim 1, wherein the tunnel has one of a U-shape and an S-shape.

10. A system for detecting a radio frequency identification tag on an object, comprising:
a tunnel, having a straight portion and at least one curved portion, for the object to pass through; and
an antenna array, arranged along a perimeter of the straight portion, for detecting the radio frequency identification tag when the object passes through the tunnel;
wherein the straight portion has two opposite ends, and the at least one curved portion is in connection with one of the two opposite ends.

11. The system of claim 10, wherein the antenna array comprises four antennas, equally spaced along the perimeter, for forming a distinguishable pattern of an electromagnetic signal responsive to the radio frequency identification tag.

12. The system of claim 10, wherein the perimeter determines a cutoff frequency of the tunnel, and the antenna array operates at an operating frequency lower than the cutoff frequency.

13. The system of claim 10, further comprising a conveyer, running through the tunnel, for carrying the object and controlling movement of the object.

14. The system of claim 10, wherein the tunnel comprises an inner surface and an outer surface, the inner surface is provided with a microwave absorber, and the outer surface is covered by a metal material.

15. The system of claim 10, further comprising a processor for analyzing an electromagnetic pattern of signal, from the object, detected by the antenna array.

16. The system of claim 10, wherein the tunnel has an opening and the system comprises a shield for selectively covering the opening.

17. The system of claim 10, wherein a cross-section of the straight portion is a circular area.

18. The system of claim 10, wherein a cross-section of the straight portion is a rectangular area.

19. The system of claim 10, wherein the tunnel has one of a U-shape and an S-shape.
